(19) United States
(12) Patent Application Publication
(10) Pub. No.: US 2013/0108792 A1
(43) Pub. Date: May 2, 2013

(54) LOADING AND UNLOADING SYSTEM FOR THIN FILM FORMATION AND METHOD THEREOF

(71) Applicant: Cheng Chieh Yang, Taoyuan City (TW)

(72) Inventor: Cheng Chieh Yang, Taoyuan City (TW)

(73) Assignee: PINECONE MATERIAL INC., Taipei City (TW)

(21) Appl. No.: 13/282,125

(22) Filed: Oct. 26, 2011

(51) Int. Cl. B05C 13/00; B05D 1/00; B05D 1/36; B05C 5/00

(52) U.S. Cl. 427/294; 118/50

(57) ABSTRACT

A system for forming one or more layers of material on one or more substrates is described. The system includes a vacuum chamber and a showerhead located in the vacuum chamber. A door in a wall of the vacuum chamber allows for loading and unloading of the one or more substrates in the vacuum chamber while under vacuum. A drive mechanism coupled to the showerhead moves the showerhead between a first position and a second position while under vacuum. In the first position, the showerhead is positioned to allow access to the door for loading and unloading of the one or more substrates through the door. In the second position, the showerhead is positioned to inhibit access to the door inside the vacuum chamber.

### BACKGROUND

1. Field of the Invention

The present invention relates to a thin film deposition apparatus. More particularly the invention relates to a vacuum chamber used for deposition of thin film materials on substrates.

2. Description of Related Art

Thin film deposition has been widely used for surface processing of various objects such as jewelry, dishware, tools, molds, and/or semiconductor devices. Often, thin films of homogeneous or heterogeneous compositions are formed on surfaces of metals, alloys, ceramics, and/or semiconductors to improve, for example, wear resistance, heat resistance, and/or corrosion resistance. The techniques of thin film deposition are typically classified into at least two categories—physical vapor deposition (PVD) and chemical vapor deposition (CVD).

Depending on the deposition technique and process parameters, the deposited thin films may have a crystalline, polycrystalline, or amorphous structure. Crystalline and/or polycrystalline thin films often are formed as epitaxial layers, which are important in the fabrication of semiconductor devices and integrated circuits. For example, epitaxial layers may be made of semiconductor layers and doped during formation to produce dopant profiles under conditions (e.g., vacuum conditions) that inhibit contamination by oxygen and/or carbon impurities.

One type of CVD process is called metal-organic chemical vapor deposition (MOCVD). For MOCVD, one or more carrier gases are used to carry one or more gas-phase reagents and/or precursors into a reaction chamber (e.g., a vacuum chamber) that contains one or more substrates (e.g., semiconductor substrates (wafers)). The backsides of the substrates are usually heated through radio-frequency (RF) induction or by a resistive heating element to raise the temperature of the substrates. At the elevated temperature, one or more chemical reactions may occur that convert the reagents and/or precursors (e.g., in gas phase) into one or more solid products that are deposited on the surfaces of the substrates.

In certain processes, epitaxial layers made by MOCVD are used to make light emitting diodes (LEDs). The quality of LEDs formed using MOCVD are affected by various factors such as, but not limited to, flow stability or uniformity inside the reaction chamber, flow uniformity across the substrate surfaces, and/or accuracy of temperature control. Variations in these factors may adversely affect the quality of epitaxial layers formed using MOCVD and, hence, the quality of LEDs produced using MOCVD.

Thus, there is a need for systems and methods that improve techniques for forming epitaxial layers using MOCVD. Particularly, there is a need for improvement of flow uniformity in the vacuum chamber and across the surfaces of the substrates during deposition of the epitaxial layers.

### SUMMARY

In certain embodiments, a system for forming one or more layers of material on one or more substrates includes a vacuum chamber and a showerhead located in the vacuum chamber. A door in a wall of the vacuum chamber may allow for loading and unloading of the one or more substrates in the vacuum chamber while under vacuum. A drive mechanism coupled to the showerhead may move the showerhead between a first position and a second position while under vacuum. In the first position, the showerhead is positioned to allow access to the door for loading and unloading of the one or more substrates through the door. In the second position, the showerhead is positioned to inhibit access to the door inside the vacuum chamber.

In some embodiments, the showerhead is in the second position during formation of the layers of material on the one or more substrates. The second position of the showerhead may provide a uniform flow field inside the vacuum chamber during formation of the layers of material on the one or more substrates. In the second position, the showerhead isolates the door from the inside of the vacuum chamber. The door is located outside a reaction zone of the vacuum chamber.

In some embodiments, one or more substrate holders are in the vacuum chamber for holding one or more of the substrates. A lift mechanism may be coupled to at least one of the substrate holders. The lift mechanism may move the substrate holder between an upper position and a lower position. In the upper position, the substrate holder is positioned to be loaded and unloaded through the door. In the lower position, the substrate holder is positioned for formation of the layers of material on the one or more substrates.

In some embodiments, a susceptor is located in the vacuum chamber for supporting the one or more substrates. A lift mechanism may be coupled to the susceptor to move the susceptor between an upper position and a lower position. In the upper position, the susceptor is positioned to be loaded and unloaded through the door. In the lower position, the susceptor is positioned for formation of the layers of material on the one or more substrates.

### BRIEF DESCRIPTION OF THE DRAWINGS

Features and advantages of the methods and apparatus of the present invention will be more fully appreciated by reference to the following detailed description of presently preferred but nonetheless illustrative embodiments in accordance with the present invention when taken in conjunction with the accompanying drawings in which:

FIG. 1 depicts a cross-sectional representation of a portion of an embodiment of a deposition chamber.

FIG. 2 depicts a cross-sectional representation of a portion of an embodiment of a deposition chamber with the showerhead position for loading/unloading of substrates.

FIG. 3 depicts a cross-sectional representation of a portion of another embodiment of a deposition chamber.

FIG. 4 depicts a cross-sectional representation of an embodiment of a chamber with a lift mechanism that raises and lowers a substrate holder and the showerhead in the deposition position.

FIG. 5 depicts a cross-sectional representation of an embodiment of a chamber with a lift mechanism that raises and lowers a substrate holder and the showerhead in the loading/unloading position.

FIG. 6 depicts a cross-sectional representation of an embodiment of a chamber with a lift mechanism that raises and lowers a substrate holder and the showerhead and the substrate holder in the loading/unloading position.

FIG. 7 depicts a cross-sectional representation of an embodiment of a chamber with a lift mechanism that raises and lowers a substrate holder and the substrate holder removed from the chamber.

FIG. 8 depicts a cross-sectional representation of an embodiment of a chamber with a lift mechanism that raises and lowers a susceptor and the showerhead in the deposition position.

FIG. 9 depicts a cross-sectional representation of an embodiment of a chamber with a lift mechanism that raises and lowers a susceptor and the showerhead in the loading/unloading position.

FIG. 10 depicts a cross-sectional representation of an embodiment of a chamber with a lift mechanism that raises and lowers a susceptor and the showerhead and the susceptor in the loading/unloading position.

FIG. 11 depicts a cross-sectional representation of an embodiment of a chamber with a lift mechanism that raises and lowers a susceptor and the susceptor removed from the chamber.

While the invention is susceptible to various modifications and alternative forms, specific embodiments thereof are shown by way of example in the drawings and will herein be described in detail. The drawings may not be to scale. It should be understood that the drawings and detailed description thereto are not intended to limit the invention to the particular form disclosed, but to the contrary, the intention is to cover all modifications, equivalents and alternatives falling within the spirit and scope of the present invention as defined by the appended claims.

### DETAILED DESCRIPTION OF EMBODIMENTS

In the context of this patent, the term “coupled” means either a direct connection or an indirect connection (e.g., one or more intervening connections) between one or more objects or components.

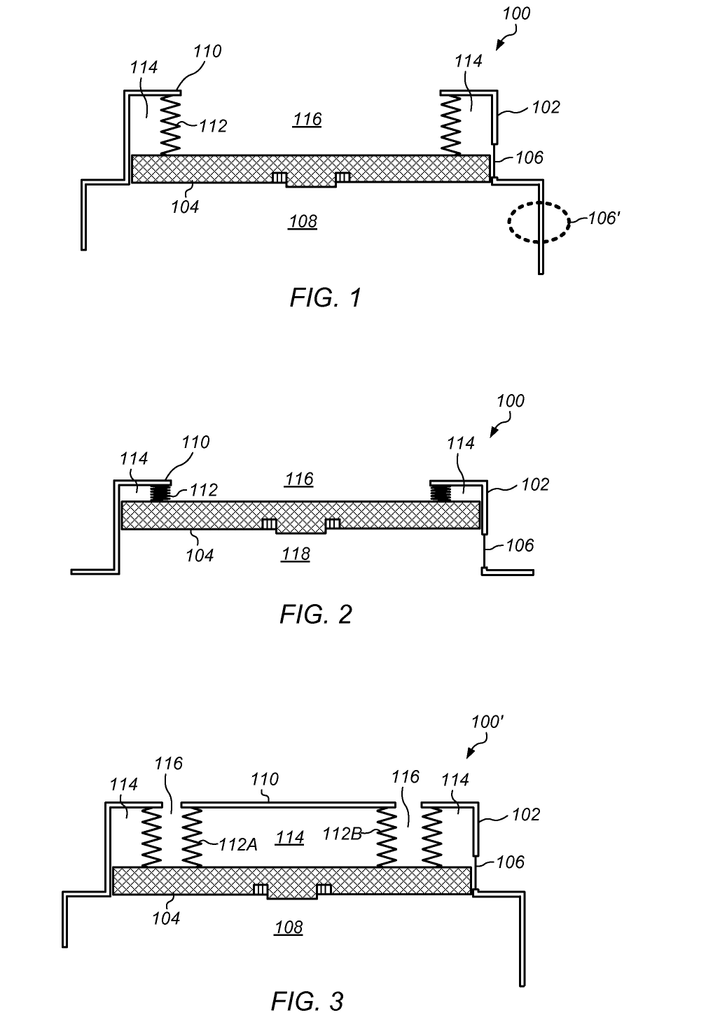

FIG. 1 depicts a cross-sectional representation of a portion of an embodiment of deposition system 100. System 100 may be, for example, system for depositing thin films onto one or more substrates. In certain embodiments, system 100 includes, or is, a vacuum chamber for depositing thin films onto one or more substrates. In one embodiment, system 100 is a chemical vapor deposition (CVD) system (e.g., the system includes a CVD chamber). In certain embodiments, system 100 includes chamber wall 102, showerhead 104, and door 106. In certain embodiments, showerhead 104 includes inlets and/or outlets for deposition gases (e.g., gas-phase reagents and/or precursors) to enter/exit system 100. In some embodiments, showerhead 104 includes excitation devices for electrically exciting gases inside system 100 (e.g., RF or microwave excitation devices).

In certain embodiments, door 106 is located in a portion of wall 102. Door 106 may be a port in wall 102 that allows access to the interior of system 100 from the exterior of the system (e.g., the vacuum chamber). Door 106 may be, for example, a doorway through wall 102 that allows for loading and unloading of substrates from system 100. In certain embodiments, door 106 allows loading and unloading of substrates under vacuum conditions. For example, door 106 may be coupled using vacuum sealed connections to another vacuum chamber such as a load chamber (e.g., a substrate load chamber). Thus, substrates may be moved into and out of system 100 (loaded/unloaded) through door 106 without breaking vacuum conditions inside the system (e.g., the vacuum chamber).

In certain embodiments, door 106 is located in a portion of wall 102 that is removed (isolated) from reaction zone 108 when showerhead 104 is located in position for deposition (formation) of thin films on substrates in system 100 (e.g., the position of the showerhead shown in FIG. 1). As shown in FIG. 1, in the deposition position, showerhead 104 inhibits access to door 106 and isolates the door from the inside of system 100. During the deposition process, because door 106 is located away from reaction zone 108 and blocked by showerhead 104, the door and its uneven geometry (e.g., uneven surfaces) do not affect the deposition process. Thus, gases/fluids in reaction zone 108 have a relatively uniform flow field inside the reaction zone due to the relatively smooth surface profile of wall 102 and showerhead 104 surrounding the reaction zone, as shown in FIG. 1. Such a uniform flow field may not be provided if the door is located at a typical location used in the prior art (the prior art door location is shown as door 106′ in FIG. 1). Door 106′ may provide uneven surfaces for flow of gases/fluids inside reaction zone 108 that cause disturbance flow inside the reaction zone during the deposition process.

In certain embodiments, drive mechanism 110 is coupled to showerhead 104. Drive mechanism 110 may move showerhead 104 between a deposition position, depicted in FIG. 1, and a loading/unloading position, depicted in FIG. 2. For example, drive mechanism 110 may raise and lower showerhead 104 between the deposition position and the loading/unloading position. As shown in FIG. 2, in the loading/unloading position, showerhead 104 is moved to allow access to system 100 through door 106. For example, a robot arm or other mechanical arm may access system 100 through door 106 to load/unload substrates from the system.

In certain embodiments, drive mechanism 110 includes one or more bellows 112. Bellow 112 may be, for example, a vacuum bellow or a welded bellow such as those available from VACOM (Jena, Germany). In some embodiments, bellow 112 has a first end coupled (e.g., welded) to a portion of wall 102 and a second end coupled (welded) to an upper surface of showerhead 104, as shown in FIG. 1. Bellow 112 may be sealed between wall 102 and showerhead 104 to maintain vacuum inside system 100 (e.g., the vacuum is maintained in space 114 between the bellow and the wall) while the inside of the bellow (space 116) is at atmospheric conditions. Bellow 112 allows showerhead 104 to raise and lower between the deposition position and the loading/unloading position while under vacuum conditions (e.g., the showerhead is raised and lowered without breaking vacuum on system 100).

In some embodiments, piping for inlets/outlets in showerhead 104 is located in space 116 inside bellow 112. In some embodiments, electrical and/or mechanical connections to showerhead 104 (e.g., electrical or mechanical connections for devices used to raise and lower the showerhead) are located in space 116 inside bellow 112. For example, a shaft or other device coupled to showerhead 104 may be located in space 116 to raise and lower the showerhead. In some embodiments, drive mechanism 110 includes more than one bellows 112 coupled to showerhead 104 to assist in raising and lowering the showerhead. For example, two bellows 112A and 112B are shown in the embodiment of system 100′ depicted in FIG. 3.

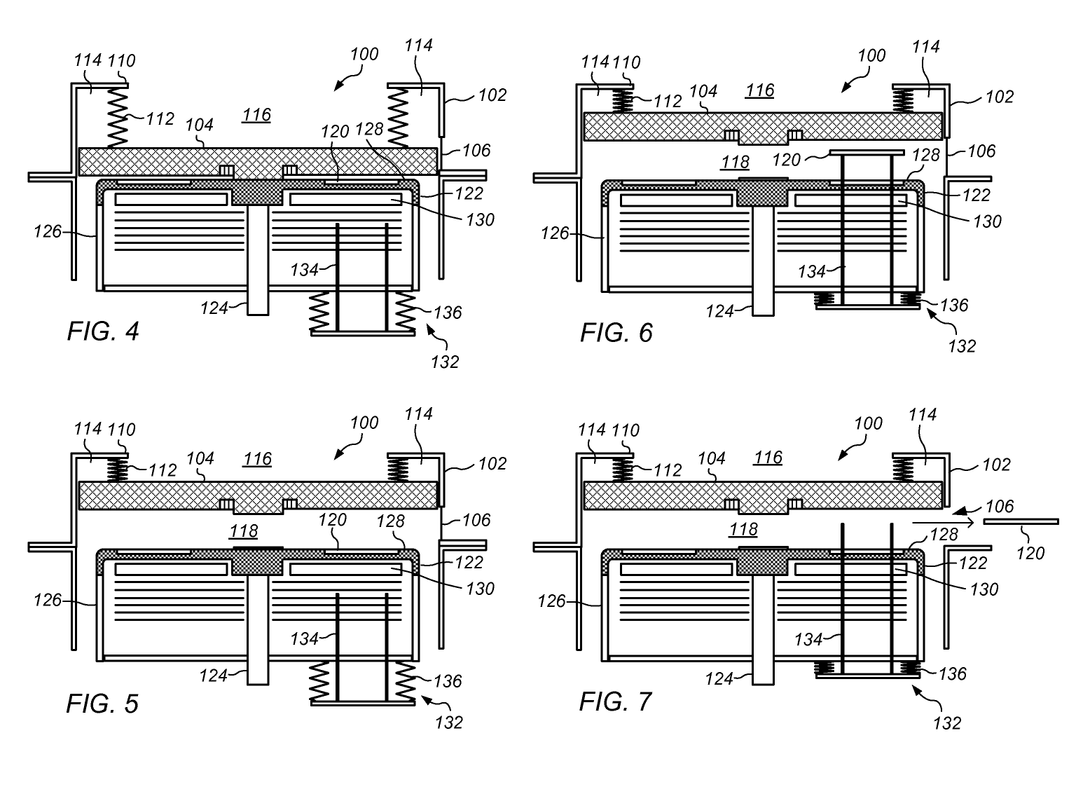

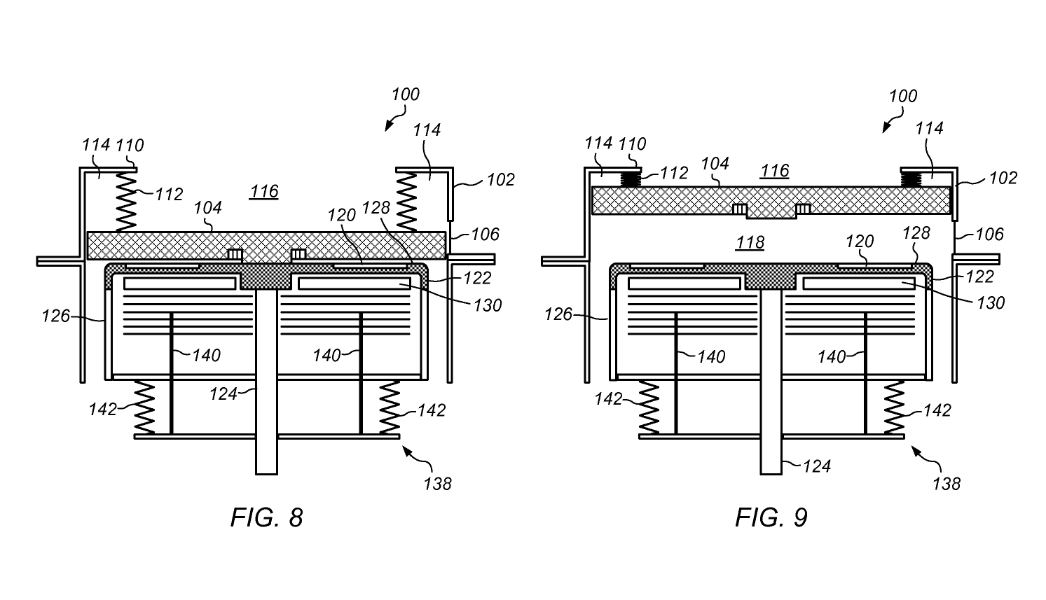

When showerhead 104 is raised into the loading/unloading position, as shown in FIG. 2, space 118 below the showerhead allows for raising a substrate holder and/or a susceptor into the space to load/unload substrates from system 100. A lift mechanism may be used to raise the substrate holder or the susceptor into space 118 (and lower them out of the space) below showerhead 104. FIGS. 4-7 depict cross-sectional representations of an embodiment of system 100 with a lift mechanism that raises and lowers a substrate holder. FIGS. 8-11 depict cross-sectional representations of an embodiment of system 100 with a lift mechanism that raises and lowers a susceptor.

FIG. 4 depicts showerhead 104 in the deposition position (inhibiting access to door 106). One or more substrates may be located on substrate holder 120 on susceptor 122. Susceptor 122 may rotate inside system 100 during deposition. For example, susceptor 122 may be rotated around a central susceptor axis using susceptor driving mechanism 124 and/or rotating shell 126. In some embodiments, rotating shell 126 supports susceptor 122.

In certain embodiments, substrate holder 120 is supported by holder gear 128. Holder gear 128 may engage a central gear that rotates the holder gear and substrate holder 120 around a holder axis of the holder gear while the holder gear and the substrate holder rotate on susceptor 122 around the central susceptor axis. Examples of the interaction of substrate holder 120, susceptor 122, rotating shell 126, holder gear 128, and the central gear are described in U.S. patent application Ser. No. 13/162,431, which is incorporated by reference as if fully set forth herein. In some embodiments, heater 130 is located below substrate holder 120 and holder gear 128 to provide heat to the substrates during deposition.

In certain embodiments, substrate holder 120 is separable from holder gear 128. Thus, substrate holder 120 may be loaded/unloaded from system 100 to load/unload substrates from the system. Holder gear 128 may remain in place on susceptor 122 while substrate holder 120 is unloaded and a replacement substrate holder with new substrates is loaded into system 100. For example, substrate holder 120 may be a platen or other flat structure that supports one or more substrates and fits into holder gear 128. Because holder gear 128 typically has teeth that engage teeth on the central gear, having substrate holder 120 separate from the holder gear (and the holder gear remaining in place) provides easier alignment during loading than removing the holder gear and attempting to align and engage teeth on a new holder gear with the teeth on the central gear.

In certain embodiments, lift mechanism 132 includes one or more supports 134 and bellow 136. Supports 134 may include, for example, pins that fit through gaps, hollows, or openings in heater 130 and/or susceptor 122 to engage and support the lower surface of substrate holder 120 when raising the substrate holder (as shown in FIGS. 6 and 7). For example, supports 134 may penetrate through gaps or other spaces between heating elements (e.g., spiral heating elements) of heater 130 and/or gaps or other spaces (e.g., hollows or openings) in susceptor 122. In some embodiments, substrate holder 120 includes openings (e.g., hollows) on its lower surface that supports 134 fit into to engage the substrate holder.

Bellow 136 may be, for example, a vacuum bellow or a welded bellow such as those available from VACOM (Jena, Germany). Bellow 136 may be coupled (e.g., welded) to a wall of system 100 with supports 134 inside the bellow such that the supports are inside the vacuum of the system. In some embodiments, supports 134 are attached to an end of bellow 136 such that the supports move with the end of the bellow while remaining under vacuum condition. For example, supports 134 may move up when bellow 136 is compressed (as shown in FIGS. 6 and 7).

FIG. 5 depicts showerhead 104 moved to the loading/unloading position to provide space 118 between the showerhead and susceptor 122 and allow access to system 100 through door 106. After showerhead 104 is moved to the loading/unloading position, lift mechanism 132 may move substrate holder 120 into a loading/unloading position in space 118 while under vacuum conditions, as shown in FIG. 6. In the loading/unloading position, substrate holder 120 may be removed from system 100 (e.g., by a robot arm or other mechanical device), as shown in FIG. 7. For example, substrate holder 120 may be moved into another vacuum chamber, such as a load chamber or transfer chamber that is coupled to system 100 under vacuum conditions. Once substrate holder 120 is removed from system 100, another substrate holder may be loaded into the vacated substrate holder position on susceptor 122 to provide new substrates for deposition into the system.

The unloading/loading process may be repeated for additional substrate holders on susceptor 122 until all or a desired number of substrate holders are replaced with new substrate holders. Susceptor 122 may be rotated to put each substrate holder into position to be removed from system 100 through door 106. In some embodiments, a single lift mechanism engages each individual substrate holder when the substrate holder is rotated into the loading/unloading position. In other embodiments, each substrate holder has its own individual lift mechanism that rotates along with the substrate holder.

FIG. 8 depicts showerhead 104 in the deposition position (inhibiting access to door 106) with lift mechanism 138 that raises and lowers susceptor 122. In the embodiment depicted in FIG. 8, substrate holder 120 and holder gear 128 may be one single unit as the substrate holder is not separated from the holder gear during unloading of substrates from system 100. In certain embodiments, lift mechanism 138 includes support 140 and bellow 142. In certain embodiments, lift mechanism 138 includes susceptor driving mechanism 124 (e.g., a central shaft of the susceptor driving mechanism). For example, the central shaft of susceptor driving mechanism 124 may be designed move up and down to raise and lower susceptor 122.

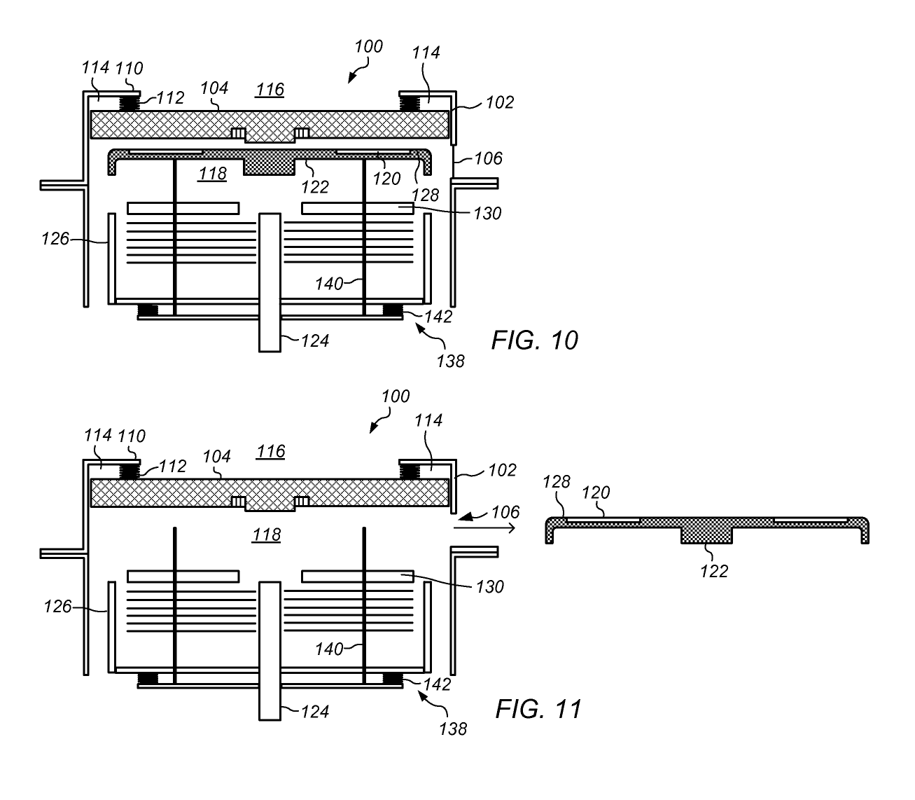

Supports 140 may include, for example, two or more pins that fit through gaps in heater 130 to engage and support the lower surface of susceptor 122 when raising the susceptor (as shown in FIG. 10). For example, support 140 may penetrate through gaps or other spaces between heating elements (e.g., spiral heating elements) of heater 130. Support 140 may engage any portion of susceptor 122 that allows the entire susceptor to be raised. In some embodiments, susceptor 122 includes openings (e.g., hollows) on its lower surface that support 140 fits into to engage the susceptor.

Bellow 142 may be, for example, a vacuum bellow or a welded bellow such as those available from VACOM (Jena, Germany). Bellow 142 may be coupled (e.g., welded) to a wall of system 100 with support 140 inside the bellow such that the support is inside the vacuum of the system. In some embodiments, support 140 is attached to an end of bellow 142 such that the supports move with the end of the bellow while remaining under vacuum condition. For example, support 140 may move up when bellow 142 is compressed (as shown in FIGS. 10 and 11).

FIG. 9 depicts showerhead 104 moved to the loading/unloading position to provide space 118 between the showerhead and susceptor 122 and allow access to system 100 through door 106. After showerhead 104 is moved to the loading/unloading position, lift mechanism 138 may move susceptor 122 into a loading/unloading position in space 118 while under vacuum conditions, as shown in FIG. 10. In the loading/unloading position, susceptor 122 may be removed from system 100 (e.g., by a robot arm or other mechanical device), as shown in FIG. 11. For example, susceptor 122 may be moved into another vacuum chamber, such as a load chamber or transfer chamber that is coupled to system 100 under vacuum conditions. Once susceptor 122 is removed from system 100, another susceptor may be loaded into the vacated susceptor position on susceptor driving mechanism 124 to provide new substrates for deposition in the system. Loading and unloading the entire susceptor allows for all substrates in system 100 to be loaded and unloaded in a single step. In certain embodiments, susceptor 122 and the central gear used to rotate holder gear 128 and substrate holder 120 are a single piece loaded and unloaded from system 100.

It is to be understood the invention is not limited to particular systems described which may, of course, vary. It is also to be understood that the terminology used herein is for the purpose of describing particular embodiments only, and is not intended to be limiting. As used in this specification, the singular forms “a”, “an” and “the” include plural referents unless the content clearly indicates otherwise. Thus, for example, reference to “a device” includes a combination of two or more devices and reference to “a material” includes mixtures of materials.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. A system for forming one or more layers of material on one or more substrates, comprising:
a vacuum chamber;
a showerhead located in the vacuum chamber;
a door in a wall of the vacuum chamber, wherein the door allows for loading and unloading of the one or more substrates in the vacuum chamber while under vacuum; and
a drive mechanism coupled to the showerhead, wherein the drive mechanism is configured to move the showerhead between a first position and a second position while under vacuum;
wherein, in the first position, the showerhead is positioned to allow access to the door for loading and unloading of the one or more substrates through the door, and wherein, in the second position, the showerhead is positioned to inhibit access to the door inside the vacuum chamber.

2. The system of claim 1, wherein the showerhead is in the second position during formation of the layers of material on the one or more substrates.

3. The system of claim 1, wherein the second position of the showerhead provides a uniform flow field inside the vacuum chamber during formation of the layers of material on the one or more substrates.

4. The system of claim 1, wherein, in the second position, the showerhead isolates the door from the inside of the vacuum chamber.

5. The system of claim 1, wherein the door is located outside a reaction zone of the vacuum chamber.

6. The system of claim 1, wherein the door, when the showerhead is in the first position, allows a robot arm to access the vacuum chamber to load and unload the one or more substrates from the vacuum chamber.

7. The system of claim 1, wherein the drive mechanism is configured to raise the showerhead into the first position and lower the showerhead into the second position.

8. The system of claim 1, wherein the drive mechanism comprises at least one vacuum bellow coupled to the showerhead.

9. The system of claim 1, further comprising one or more substrate holders in the vacuum chamber for holding one or more of the substrates.

10. The system of claim 9, further comprising a lift mechanism coupled to at least one of the substrate holders, wherein the lift mechanism is configured to move the substrate holder between an upper position and a lower position, wherein, in the upper position, the substrate holder is positioned to be loaded and unloaded through the door, and wherein, in the lower position, the substrate holder is positioned for formation of the layers of material on the one or more substrates.

11. The system of claim 10, wherein the lift mechanism comprises at least one vacuum bellow.

12. The system of claim 10, wherein the lift mechanism is configured to raise and lower the at least one of the substrate holders.

13. The system of claim 1, further comprising a susceptor in the vacuum chamber for supporting the one or more substrates.

14. The system of claim 13, further comprising a lift mechanism coupled to the susceptor, wherein the lift mechanism is configured to move the susceptor between an upper position and a lower position, wherein, in the upper position, the susceptor is positioned to be loaded and unloaded through the door, and wherein, in the lower position, the susceptor is positioned for formation of the layers of material on the one or more substrates.

15. The system of claim 14, wherein the lift mechanism comprises at least one vacuum bellow.

16. The system of claim 14, wherein the lift mechanism is configured to raise and lower the susceptor.

17. A method for forming one or more layers of material on one or more substrates, comprising:
locating a showerhead in a first position in a vacuum chamber that allows access to the vacuum chamber through a door in a wall of the vacuum chamber;
loading one or more substrates into the vacuum chamber through the door while under vacuum;
moving the showerhead, while under vacuum, to a second position such that the showerhead inhibits access to the door inside the vacuum chamber; and
forming one or more layers of material on the one or more substrates.

18. The method of claim 17, further comprising loading the one or more substrates into the vacuum chamber using a robot arm.

19. The method of claim 17, further comprising, while under vacuum:
moving the showerhead to the first position after formation of the one or more layers of material on the one or more substrates; and
unloading the one or more substrates with the one or more layers of material formed on them through the door.

20. The method of claim 19, further comprising unloading the one or more substrates from the vacuum chamber using a robot arm.

21. The method of claim 17, further comprising, while under vacuum:
moving the showerhead to the first position after formation of the one or more layers of material on the one or more substrates;
unloading the one or more substrates with the one or more layers of material formed on them through the door;
loading one or more additional substrates into the vacuum chamber through the door;
moving the showerhead to the second position; and
forming one or more layers of material on the one or more additional substrates.

22. The method of claim 17, further comprising forming the one or more layers of material in a deposition process using the showerhead.

23. The method of claim 17, wherein the position of the showerhead during formation of the layers of material on the one or more substrates produces a uniform flow field inside the vacuum chamber.

24. The method of claim 17, further comprising locating one or more of the substrates on one or more substrate holders in the vacuum chamber.

25. The method of claim 24, further comprising moving at least one of the substrate holders into an upper position when loading one or more substrates into the vacuum chamber through the door.

26. The method of claim 24, further comprising moving at least one of the substrate holders into a lower position before forming the layers of material on the one or more substrates.

27. The method of claim 17, further comprising loading the one or more substrates into the vacuum chamber by loading a susceptor with the substrates into the vacuum chamber.

28. The method of claim 26, further comprising moving the susceptor into a lower position before forming the layers of material on the one or more substrates.
